(19) United States
(12) Patent Application Publication
(10) Pub. No.: US 2024/0170004 A1
(43) Pub. Date: May 23, 2024

(54) CONTEXT AWARE AUDIO PROCESSING

(71) Applicant: Dolby Laboratories Licensing Corporation, San Francisco, CA (US)

(72) Inventors: Zhiwei SHUANG, Beijing (CN); Yuanxing MA, Beijing (CN); Yang LIU, Beijing (CN)

(73) Assignee: Dolby Laboratories Licensing Corporation, San Francisco, CA (US)

(21) Appl. No.: 18/548,750

(22) PCT Filed: Apr. 28, 2022
(86) PCT No.: PCT/US2022/026827

§ 371 Date: Sep. 1, 2023

Related U.S. Application Data
(60) Provisional application No. 63/197,588, filed on Jun. 7, 2021.
(60) Provisional application No. 63/195,576, filed on Jun. 1, 2021.

(30) Foreign Application Priority Data
Apr. 29, 2021 (WO) PCT/CN2021/090959
May 12, 2021 (WO) PCT/CN2021/093401

(51) Int. Cl. G10L 21/0364; G10L 21/034; G10L 25/18; G10L 25/30; G10L 25/78

(52) U.S. Cl. CPC G10L 21/0364; G10L 21/034; G10L 25/18; G10L 25/30; G10L 25/78

(57) ABSTRACT

Embodiments are disclosed for context aware audio processing. In an embodiment, an audio processing method comprises: receiving, with one or more sensors of a device, environment information about an audio recording captured by the device; detecting, with at least one processor of the device, a context of the audio recording based on the audio recording and the environment information; determining, with the at least one processor, a model based on the context; processing, with the at least one processor, the audio recording based on the model to produce a processed audio recording with suppressed noise; determining, with the at least one processor, an audio processing profile based on the context; and combining, with the at least one processor, the audio recording and the processed audio recording based on the audio processing profile.

### CROSS-REFERENCE TO RELATED APPLICATIONS

This application claims the benefit of priority from U.S. Provisional Patent Application No. 63/197,588, filed on Jun. 7, 2021, U.S. Provisional Patent Application No. 63/195,576, filed on Jun. 1, 2021, International Application No. PCT/CN2021/093401, filed on May 12, 2021, and International Application No. PCT/CN2021/090959, filed on Apr. 29, 2021, which are hereby incorporated by reference.

### TECHNICAL FIELD

This disclosure relates generally to audio signal processing, and more particularly to processing user-generated content (UGC).

### BACKGROUND

UGC is typically created by consumers and can include any form of content (e.g., images, videos, text, audio). UGC is typically posted by its creator to online platforms, including but not limited to social media, blogs, wikis and the like. One trend related to UGC is personal moment sharing in variable environments (e.g., indoors, outdoors, by the sea) by recording video and audio using a personal mobile device (e.g., smart phone, tablet computer, wearable devices). Most UGC content contains audio artifacts due to consumer hardware limitations and a non-professional recording environment. The traditional way of UGC processing is based on audio signal analysis or artificial intelligence (AI) based noise reduction and enhancement processing. One difficulty in processing UGC is how to treat different sound types in different audio environments while maintaining the creative objective of content creator.

### SUMMARY

Embodiments are disclosed for context aware audio processing.

In some embodiments, an audio processing method comprises: receiving, with one or more sensors of a device, environment information about an audio recording captured by the device; detecting, with at least one processor of the device, a context of the audio recording based on the audio recording and the environment information; determining, with the at least one processor, a model based on the context; processing, with the at least one processor, the audio recording based on the model to produce a processed audio recording with suppressed noise; determining, with the at least one processor, an audio processing profile based on the context; and combining, with the at least one processor, the audio recording and the processed audio recording based on the audio processing profile.

In some embodiments, the context indicates that the audio recording was captured indoors or outdoors.

In some embodiments, the context is detected using an audio scene classifier.

In some embodiments, the context is detected using the audio scene classifier in combination with a physical state of the device determined at least in part by the environment information.

In some embodiments, the context is detected using the audio scene classifier in combination with a physical state of the device determined at least in part by the environment information and visual information obtained by an image capture sensor device of the device.

In some embodiments, the context indicates that the audio recording was captured while being transported.

In some embodiments, the audio recording an binaural recording.

In some embodiments, the context is determined at least in part based on a location of the device as determined by a position system of the device.

In some embodiments, the audio processing profile includes at least a mixing ratio for mixing the audio recording with the processed audio recording.

In some embodiments, the mixing ratio is controlled at least in part based on the context.

In some embodiments, the audio processing profile includes at least one of an equalization curve or dynamic range control data.

In some embodiments, processing, with the at least one processor, the audio recording based on the model to produce a processed audio recording comprises: obtaining a speech frame from the audio recording; computing a frequency spectrum of the speech frame, the frequency spectrum including a plurality of frequency bins; extracting frequency band features from the plurality of frequency bins; estimating gains for each of the plurality of frequency bands based on the frequency band features and the model; adjusting the estimated gains based on the audio processing profile; converting the frequency band gains into frequency bin gains; modifying the frequency bins with the frequency bin gains; reconstructing the speech frame from the modified frequency bins; and converting the reconstructed speech frame into an output speech frame.

In some embodiments, the band features include at least one of Mel-Frequency Cepstral Coefficients (MFCC), Bark Frequency Cepstral Coefficients (BFCC), or a band harmonicity feature indicating how much the band is composed of a periodic audio signal.

In some embodiments, the band features include the harmonicity feature and the harmonicity feature is computed from the frequency bins of the speech frame or calculated by correlation between the speech frame and a previous speech frame.

In some embodiments, the model is a deep neural network (DNN) model that is configured to estimate the gains and voice activity detection (VAD) for each frequency band of the speech frame based on the band features and a fundamental frequency of the speech frame.

In some embodiments, a Wiener Filter or other estimator is combined with the DNN model to compute the estimated gains.

In some embodiments, the audio recording was captured near a body of water and the model is trained with audio samples of tides and associated noise.

In some embodiments, the training data is separated into two datasets: a first dataset that includes the tide samples and a second dataset that includes the associated noise samples.

In some embodiments, a system of processing audio, comprising: one or more processors; and a non-transitory computer-readable medium storing instructions that, when executed by the one or more processors, cause the one or more processors to perform any of the preceding methods.

In some embodiments, a non-transitory computer-readable medium storing instructions that, when executed by the one or more processors, cause the one or more processors to perform any of the preceding methods.

Particular embodiments disclosed herein provide one or more of the following advantages. The disclosed context aware audio processing embodiments can be used for binaural recordings to capture a realistic binaural soundscape while maintaining the creative objective of the content creator.

### DESCRIPTION OF DRAWINGS

In the drawings, specific arrangements or orderings of schematic elements, such as those representing devices, units, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

FIG. 1 illustrates binaural recording using earbuds and a mobile device, according to an embodiment.

FIG. 2 is a block diagram of a system for context aware audio processing, according to an embodiment.

FIG. 3 is a flow diagram of a process of context aware audio processing, according to an embodiment.

FIG. 4 is a block diagram of an example device architecture for implementing the features and processes described in reference to FIGS. 1-3, according to an embodiment.

The same reference symbol used in various drawings indicates like elements.

### DETAILED DESCRIPTION

In the following detailed description, numerous specific details are set forth to provide a thorough understanding of the various described embodiments. It will be apparent to one of ordinary skill in the art that the various described embodiments may be practiced without these specific details. In other instances, well-known methods, procedures, components, and circuits, have not been described in detail so as not to unnecessarily obscure aspects of the embodiments. Several features are described hereafter that can each be used independently of one another or with any combination of other features.

### Nomenclature

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “an example embodiment” are to be read as “at least one example embodiment.” The term “another embodiment” is to be read as “at least one other embodiment.” The terms “determined,” “determines,” or “determining” are to be read as obtaining, receiving, computing, calculating, estimating, predicting or deriving. In addition, in the following description and claims, unless defined otherwise, all technical and scientific terms used herein have the same meaning as commonly understood by one of ordinary skills in the art to which this disclosure belongs.

### Example System

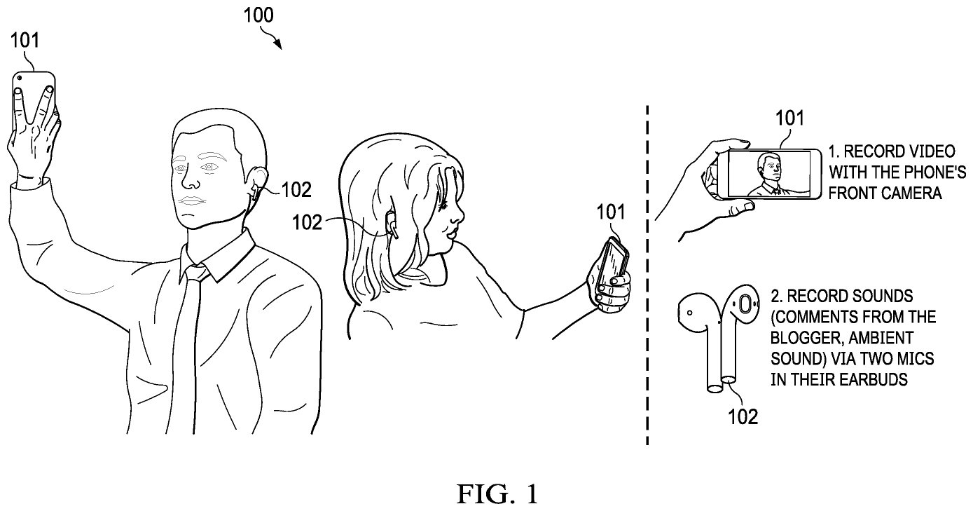

FIG. 1 illustrates binaural recording using earbuds and a mobile device, according to an embodiment. System 100 includes a two-step process of recording video with a video camera of a mobile device 101 (e.g., a smartphone), and concurrently recording audio associated with the video recording. In an embodiment, the audio recording can be made by, for example, mobile device 101 recording audio signals output by microphones embedded in earbuds 102. The audio signals can include but are not limited to comments spoken by a user and/or ambient sound. If both the left and right microphones are used then a binaural recording can be captured. In some implementations, microphones embedded or attached to mobile device 101 can also be used.

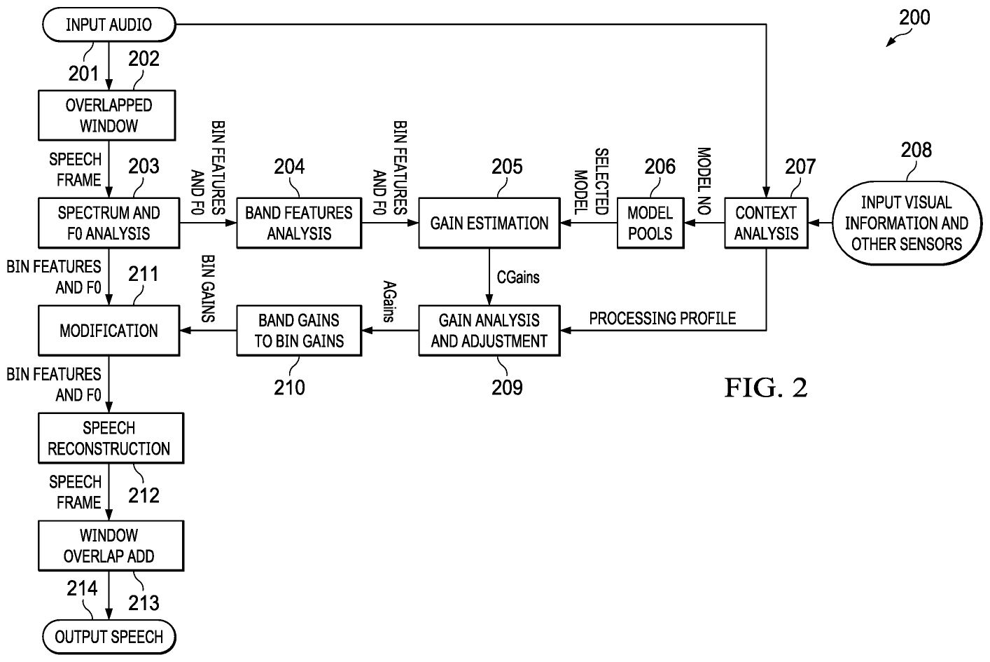

FIG. 2 is a block diagram of a system 200 for context aware audio processing, according to an embodiment. System 200 includes window processor 202, spectrum analyzer 203, band feature analyzer 204, gain estimator 205, machine learning model 206, context analyzer 207, gain analyzer/adjuster 209, band gain to bin gain converter 210, spectrum modifier 211, speech reconstructor 212 and window overlap-add processor 213.

Window processor 202 generates a speech frame comprising overlapping windows of samples of input audio 201 containing speech (e.g., an audio recording captured by mobile device 101). The speech frame is input into spectrum analyzer 203 which generates frequency bin features and a fundamental frequency (F0). The analyzed spectrum information can be represented by: Fast Fourier transform (FFT) spectrum, Quadrature Mirror Filter (QMF) features or any other audio analysis process. The bins are scaled by spectrum modifier 211 and input into speech reconstructor 212 which outputs a reconstructed speech frame. The reconstructed speech frame is input into window overlap-add processor 213, which generates output speech.

Referring back to step 203 the bin features and F0 are input into band feature analyzer 204, which outputs band features and F0. In an embodiment, the band features are extracted based on FFT parameters. Band features can include but are not limited to: MFCC and BFCC. In an embodiment, a band harmonicity feature can be computed, which indicates how much a current frequency band is composed of a periodic signal. In an embodiment, the harmonicity feature can be calculated based on FFT frequency bins of a current speech frame. In other embodiments, the harmonicity feature is calculated by a correlation between the current speech frame and a previous speech frame.

The band features and F0 are input into gain estimator 205 which estimates gains (CGains) for noise reduction based on a model selected from model pool 206. In an embodiment, the model is selected based on a model number output by context analyzer 207 in response to input visual information and other sensor information. In an embodiment, the model is a deep neural network (DNN) trained to estimate gains and VAD for each frequency band based on the band features and F0. The DNN model can be based on a fully connected neural network (FCNN), recurrent neural network (RNN) or convolutional neural network (CNN) or any combination of FCNN, RNN and CNN. In an embodiment, a Wiener Filter or other suitable estimator can be combined with the DNN model to get the final estimated gains for noise reduction.

The estimated gains, CGains, are input into gain analyzer/adjuster 209 which generates adjusted gains, AGains, based on an audio processing profile. The adjusted gains, AGains, is input into band gain to bin gain converter 210, which generates adjusted bin gains. The adjusted bin gains are input spectrum modifier 211 which applies the adjusted bin gains to their corresponding frequency bins (e.g., scales the bin magnitudes by their respective adjusted bin gains). The adjusted bin features are then input into speech reconstructor 212, which outputs a reconstructed speech frame. The reconstructed speech frame is input into window overlap-add processor 212, which generates reconstructed output speech using an overlap and add algorithm.

In an embodiment, the model number is output by context analyzer 207 based on input audio 201 and input visual information and/or other sensors data 208. Context analyzer 207 can include one or more audio scene classifiers trained to classify audio content into one or more classes representing recording locations. In an embodiment, the recording location classes are indoors, outdoors and transportation. For each class, a specific audio processing profile can be assigned. In another embodiment, context analyzer 207 is trained to classify a more specific recording location (e.g., sea bay, forest, concert, meeting room, etc.).

In another embodiment, context analyzer 207 is trained using visual information, such as digital pictures and video recordings, or a combination of an audio recording and visual information. In other embodiments, other sensor data can be used to determine context, such as inertial sensors (e.g., accelerometers, gyros) or position technologies, such as global navigation satellite systems (GNSS), cellular networks or WIFI fingerprinting. For example, the accelerometer and gyroscope and/or Global Position System (GPS) data can be used to determine a speed of mobile device 101. The speed can be combined with the audio recording and/or visual information to determine whether the mobile device 101 is being transported (e.g., in a vehicle, bus, airplane, etc.).

In an embodiment, different models can be trained for different scenarios to achieve better performance. For example, for a sea bay recording location, the model can include the sound of tides. The training data can be adjusted to achieve different model behaviors. When a model is trained, the training data can be separated into two parts: (1) a target audio database containing signal portions of the input audio to be maintained in the output speech, and (2) a noise audio database which contains noise portions of the input audio that needs to be suppressed in the output speech. Different training data can be defined to train different models for different recording locations. For example, for the sea bay model, the sound of tides can be added to the target audio database to make sure the model maintains the sound of tides. After defining the specific training database, traditional training procedures can be used to train the models.

In an embodiment, the context information can be mapped to a specific audio processing profile. The specific audio processing profile can include a least a specific mixing ratio for mixing the input audio (e.g., the original audio recording) with the processed audio recording where noise was suppressed. The processed recording is mixed with the original recording to reduce quality degradation of the output speech. The mixing ratio is controlled by context analyzer 207 shown in FIG. 2. The mixing ratio can be applied to the input audio in the time domain, or the CGains can be adjusted with the mixing ratio according to Equation [1] below using gain adjuster 209.

Although a DNN based noise reduction algorithm can suppress noise significantly, the noise reduction algorithm may introduce significant artifacts in the output speech. Thus, to reduce the artifacts the processed audio recording is mixed with the original audio recording. In an embodiment, a fixed mixing ratio can be used. For example, the mixing ratio can be 0.25.

However, a fixed mixing ratio may not work for different contexts. Therefore, in an embodiment the mixing ratio can be adjusted based on the recording context output by context analyzer 207. To achieve this, the context is estimated based on the input audio information. For example, for the indoor class, a larger mixing ratio (e.g., 0.35) can be used. For the outdoor case, a lower mixing ratio (e.g., 0.25) can be used. For the transportation class, an even lower mixing ratio can be used (e.g., 0.2). In an embodiment where a more specific recording location can be determined, a different audio processing profile can be used. For example, for meeting room, a small mixing ratio (e.g., 0.1), can be used to remove more noise. For a concert, a larger mixing ratio such as 0.5 can be used to avoid degrading the music quality.

In an embodiment, mixing the original audio recording with the processed audio recording can be implemented by mixing the denoised audio file with the original audio file in the time domain. In another embodiment, the mixing can be implemented by adjusting the CGains with the mixing ration dMixRatio, according to Equation [1]:

AGains=CGains+dMixRatio, [1]

where if AGains>1, AGains=1.

In an embodiment, the specific audio processing profile also includes an equalization (EQ) curve and/or a dynamic range control (DRC), which can be applied in post processing. For example, if the recording location is identified as a concert, a music specific equalization curve can be applied to the output of system 200 to preserve the timbre of various music instruments, and/or the dynamic range control can be configured to do less compressing to make sure the music level is within a certain loudness range suitable for music. In a speech dominant audio scene, the equalization curve could be configured to enhance speech quality and intelligibility (e.g., boost at 1 KHz), and the dynamic range control can be configured to do more compressing to make sure the speech level is within a certain loudness range suitable for speech.

### Example Process

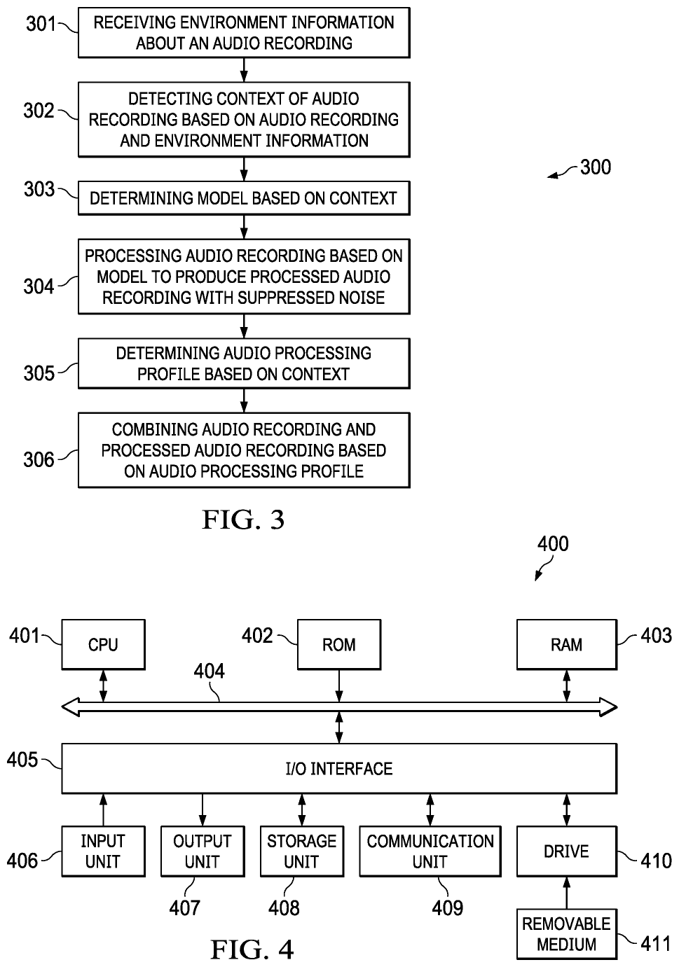

FIG. 3 is a flow diagram of process 300 of context aware audio processing, according to an embodiment. Process 300 can be implemented using, for example, device architecture 400 described in reference to FIG. 4.

Process 300 includes the steps of receiving, with one or more sensors of a device, environment information about an audio recording captured by the device (301), detecting, with at least one processor of the device, a context of the audio recording based on the audio recording and the environment information (302), determining, with the at least one processor, a model based on the context (303), processing, with the at least one processor, the audio recording based on the model to produce a processed audio recording with suppressed noise (304), determining, with the at least one processor, an audio processing profile based on the context (305), and combining, with the at least one processor, the audio recording and the processed audio recording based on the audio processing profile (306). Each of these steps were previously described in detail above in reference to FIG. 2.

### Example System Architecture

FIG. 4 shows a block diagram of an example system 400 suitable for implementing example embodiments described in reference to FIGS. 1-3. System 400 includes a central processing unit (CPU) 401 which is capable of performing various processes in accordance with a program stored in, for example, a read only memory (ROM) 402 or a program loaded from, for example, a storage unit 408 to a random access memory (RAM) 403. In the RAM 403, the data required when the CPU 401 performs the various processes is also stored, as required. The CPU 401, the ROM 402 and the RAM 403 are connected to one another via a bus 404. An input/output (I/O) interface 405 is also connected to the bus 404.

The following components are connected to the I/O interface 405: an input unit 406, that may include a keyboard, a mouse, or the like; an output unit 407 that may include a display such as a liquid crystal display (LCD) and one or more speakers; the storage unit 408 including a hard disk, or another suitable storage device; and a communication unit 409 including a network interface card such as a network card (e.g., wired or wireless).

In some embodiments, the input unit 406 includes one or more microphones in different positions (depending on the host device) enabling capture of audio signals in various formats (e.g., mono, stereo, spatial, immersive, and other suitable formats).

In some embodiments, the output unit 407 include systems with various number of speakers. The output unit 407 can render audio signals in various formats (e.g., mono, stereo, immersive, binaural, and other suitable formats).

The communication unit 409 is configured to communicate with other devices (e.g., via a network). A drive 410 is also connected to the I/O interface 405, as required. A removable medium 411, such as a magnetic disk, an optical disk, a magneto-optical disk, a flash drive or another suitable removable medium is mounted on the drive 410, so that a computer program read therefrom is installed into the storage unit 408, as required. A person skilled in the art would understand that although the system 400 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 709, and/or installed from the removable medium 411, as shown in FIG. 4.

Generally, various example embodiments of the present disclosure may be implemented in hardware or special purpose circuits (e.g., control circuitry), software, logic or any combination thereof. For example, the units discussed above can be executed by control circuitry (e.g., a CPU in combination with other components of FIG. 4), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may be non-transitory and may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1-20. (canceled)

21. An audio processing method, comprising:
receiving, with one or more sensors of a device, environment information about an audio recording captured by the device;
detecting, with at least one processor of the device, a context of the audio recording based on the audio recording and the environment information;
determining, with the at least one processor, a model based on the context;
processing, with the at least one processor, the audio recording based on the model to produce a processed audio recording with suppressed noise;
determining, with the at least one processor, an audio processing profile based on the context, wherein the audio processing profile includes at least a mixing ratio for mixing the audio recording with the processed audio recording and wherein the mixing ratio is controlled at least in part based on the context; and
combining, with the at least one processor, the audio recording and the processed audio recording based on the mixing ratio.

22. The method of claim 21, wherein the context indicates that the audio recording was captured indoors or outdoors.

23. The method of claim 21, wherein the context is detected using an audio scene classifier.

24. The method of claim 23, wherein the context is detected using the audio scene classifier in combination with a physical state of the device determined at least in part by the environment information.

25. The method of claim 23, wherein the context is detected using the audio scene classifier in combination with a physical state of the device determined at least in part by the environment information and visual information obtained by an image capture sensor device of the device.

26. The method of claim 25, wherein the context indicates that the audio recording was captured while being transported.

27. The method of claim 21, wherein the audio recording an binaural recording.

28. The method of claim 21, wherein the context is determined at least in part based on a location of the device as determined by a position system of the device.

29. The method of claim 21, wherein the audio processing profile includes at least one of an equalization curve or dynamic range control data.

30. The method of claim 21, wherein processing, with the at least one processor, the audio recording based on the model to produce a processed audio recording comprises:
obtaining a speech frame from the audio recording;
computing a frequency spectrum of the speech frame, the frequency spectrum including a plurality of frequency bins;
extracting frequency band features from the plurality of frequency bins;
estimating gains for each of the plurality of frequency bands based on the frequency band features and the model;
adjusting the estimated gains based on the audio processing profile;
converting the frequency band gains into frequency bin gains;
modifying the frequency bins with the frequency bin gains;
reconstructing the speech frame from the modified frequency bins; and
converting the reconstructed speech frame into an output speech frame.

31. The method of claim 30, wherein the band features include at least one of Mel Frequency Cepstral Coefficients (MFCC), Bark Frequency Cepstral Coefficients (BFCC), or a band harmonicity feature indicating how much the band is composed of a periodic audio signal.

32. The method of claim 30, wherein the band features include the harmonicity feature and the harmonicity feature is computed from the frequency bins of the speech frame or calculated by correlation between the speech frame and a previous speech frame.

33. The method of claim 30, wherein the model is a deep neural network (DNN) model that is configured to estimate the gains and voice activity detection (VAD) for each frequency band of the speech frame based on the band features and a fundamental frequency of the speech frame.

34. The method of claim 33, wherein a Wiener Filter is combined with the DNN model to compute the estimated gains.

35. The method of claim 21, wherein the audio recording was captured near a body of water and the model is trained with audio samples of tides and associated noise.

36. The method of claim 34, wherein the training data is separated into two datasets: a first dataset that includes the tide samples and a second dataset that includes the associated noise samples.

37. A system of processing audio, comprising:
one or more processors; and
a non-transitory computer-readable medium storing instructions that, when executed by the one or more processors, cause the one or more processors to perform operations of claim 21.

38. A non-transitory computer-readable medium storing instructions that, when executed by the one or more processors, cause the one or more processors to perform operations of claim 21.
